(19) United States
(12) Patent Application Publication
(10) Pub. No.: US 2021/0268367 A1
(43) Pub. Date: Sep. 2, 2021

(54) Anodized light emitting wheel hub

(71) Applicant: SOON CHANG KWON, GLENDALE, CA (US)

(72) Inventor: SOON CHANG KWON, GLENDALE, CA (US)

(21) Appl. No.: 16/873,232

(22) Filed: Mar. 2, 2020

(51) Int. Cl. A63C 17/22; A63C 17/26; A61G 5/10; B62B 9/00; F21V 33/00; F21V 23/00; F21V 23/02

(52) U.S. Cl. CPC A63C 17/223; A63C 17/26; A61G 5/10; B62B 9/00; A63C 2203/12; F21V 33/0004; F21V 23/001; F21V 23/02; F21V 33/008

(57) ABSTRACT

An aluminum or aluminum alloy wheel hub having at least one display opening for electrically operated display device and at least one interior channel anodized to a sufficient electrically insulative thickness, the channel is dimensioned to receive at least one electrically conductive element of a compact generator. The display device can be a LED device. The wheel hub is especially suited for roller skate, in-line skate, and skate board wheels.

### BACKGROUND OF THE INVENTION

### 1. Field of the Invention

The present invention relates to an anodized metal light emitting wheel hub. The wheel hub is for wheels used in roller skates, in-line roller skates, wheel chairs and like apparatuses.

### 2. Description of the Related Art

There are a number of light emitting wheel hubs that use compact generators positioned or embedded in a wheel hub to generate electricity for light emitting device of the wheel. Examples these light emitting wheels can be found in in U.S. Pat. No. 9,073,479 B2 (Kwon), U.S. Pat. Nos. 6,398,395, 5,580,093, 7,905,641, 9,188,295, KR 100379183B1, KR 19990078816A, KR 2008005618A. Typically, the armature assembly or yoke of the compact generator is positioned or embedded in the wheel hub of the wheel that rotates around a permanent magnet positioned on the wheel axle.

Typically, an electrically non-conductive polymer resin or plastic is injection molded around the armature assembly to form a wheel hub. The light emitting device can be a conductive plate or printed circuit board bearing light emitting element such as a LED (light emitting diode), which is connected to the wheel hub to form a wheel hub assembly such as shown in the Kwon.

Light emitting plastic or polymer wheel hubs have limited durability especially when subjected to harsh conditions such as rough roads or surfaces and extreme use conditions. Metal hubs on the other hand provides desired the strength, toughness and durability but has not been used in light emitting wheel hub due to electrical conductivity of metal and/or complexity and costs to provide electrically insulative environment necessary to house the electrical components of the compact generator of the wheel hub and light emitting device.

### SUMMARY OF THE INVENTION

Metal wheel hubs have not been successfully used for wheel hubs having built-in electrically operated display devices such as light emitting wheel hubs because of the electrical conductivity of the metal that could short out the electrical components of the light emitting wheel. The presently disclosed invention achieves the strength, toughness and durability of metal in light emitting wheel hubs not possible with polymer or resin wheel hubs. It is accomplished by anodizing aluminum or aluminum alloy wheel hub to sufficient thickness to achieve electrically insulative property. The anodized surface also advantageously allows it to be printed and/or dyed different colors and colored patterns. The aluminum or aluminum alloy wheel hub is anodized by well-known methods to a thickness sufficient to provide an electrically insulative surface when in contact with the compact generator. Anodizing also greatly improves corrosion resistance and wear characteristics of the wheel hub.

The present inventive wheel hub allow for a much larger diameter wheel hub for use in larger diameter wheel that was not hereto before possible with polymer wheel hubs. The extra strength and toughness of metal allows the light emitting wheel hub to be used in rough and demanding conditions found on rough terrain and especially extreme conditions for aggressive skates used in trick maneuvers.

The inventive method of making the present wheel hub is simple and requires no complex steps to electrically isolate the electrical components of the wheel hub. The wheel hub is formed from two separate halves. The halves can be cast or machined/milled from metal stock using, for example, computer numeric controlled machine. The halves are anodized to sufficient thickness to provide the desired non electrical conductive surface.

The present invention can use the compact generator disclosed in U.S. Pat. No. 9,073,479 (Kwon) and U.S. Pat. No. 6,398,395 (Hyun) both herein incorporated by reference in their entirety. The presently disclosed inventive anodized wheel hub can be adapted to accept other types of compact generators.

### BRIEF DESCRIPTION OF THE DRAWINGS

FIG. 1 shows front perspective view of the wheel hub with armature assembly.

FIG. 2 shows side view of the of the wheel hub.

FIG. 3 shows front view of the wheel hub.

FIG. 4 shows view of the front panel interior of the wheel hub without the armature assembly.

FIG. 5 shows top side view of the front panel of the wheel hub without the armature assembly.

FIG. 6 shows rear perspective view of the wheel hub with armature assembly.

FIG. 7 shows rear view of the rear panel of the wheel hub without the armature assembly.

FIG. 8 shows view of the rear panel interior of the wheel hub without the armature assembly.

FIG. 9 shows bottom side view of the rear panel of the wheel hub without the armature assembly.

FIG. 10 shows perspective view of the front panel interior of the wheel hub.

FIG. 11 shows armature assembly and LED circuit board.

FIG. 12 shows perspective view of the rear panel interior of the wheel hub.

FIG. 13 shows front view of wheel hub and LED circuit board with transparent cap removed.

FIG. 14 shows bottom side view of the wheel hub with transparent cap covering.

FIG. 14 shows exploded perspective view of the wheel bearing, compact generator and wheel.

### DETAILED DESCRIPTION OF THE INVENTION

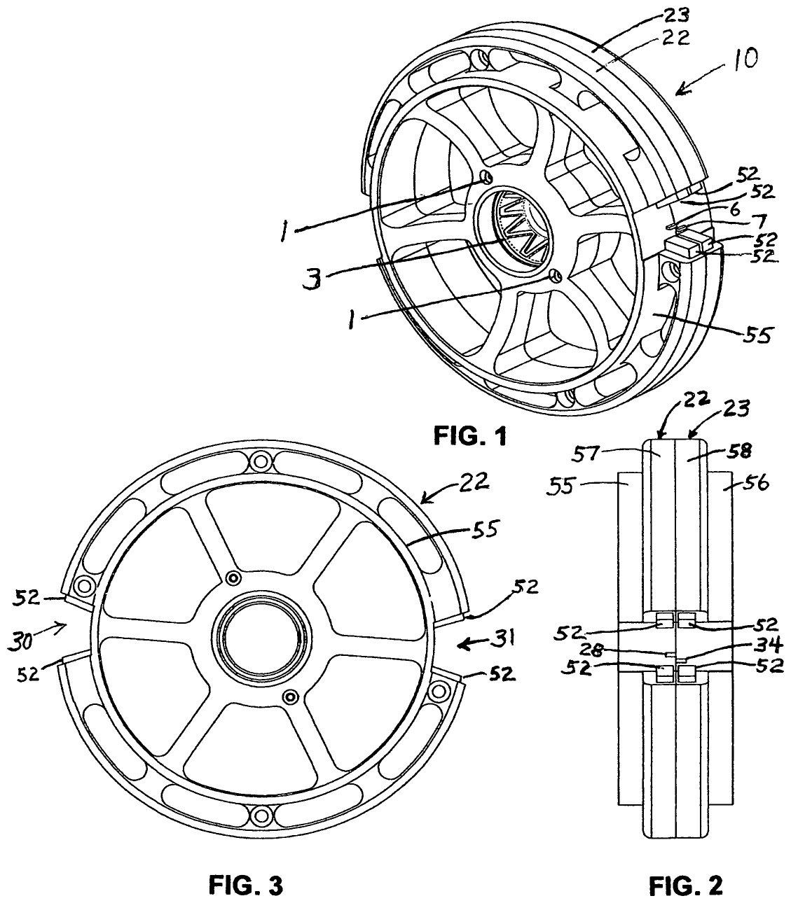

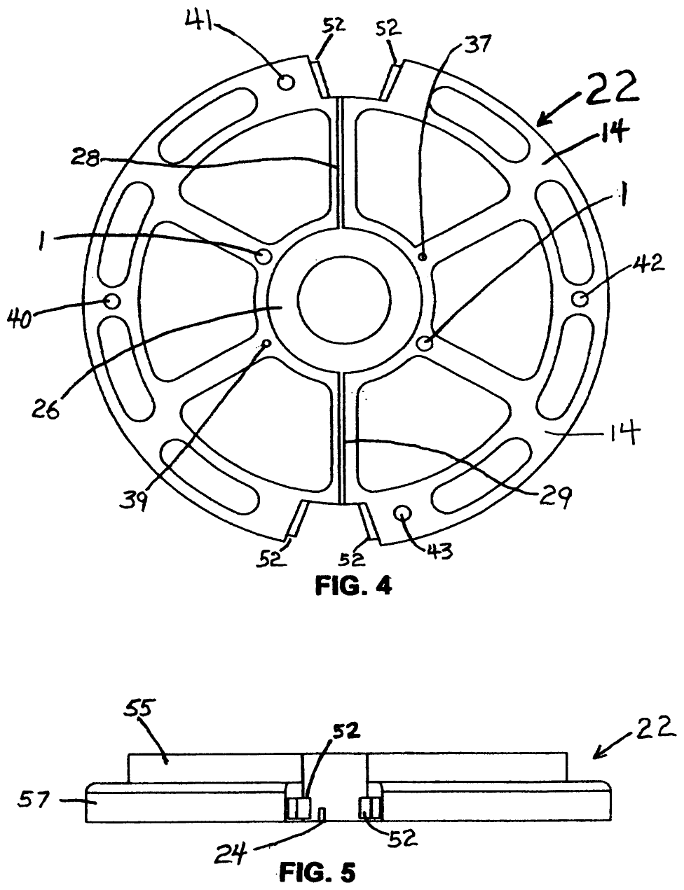

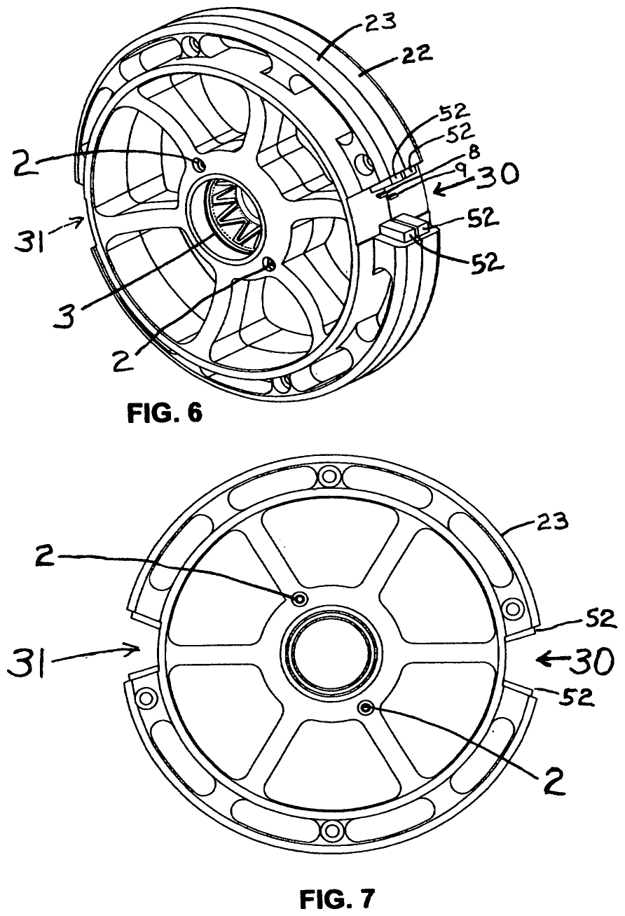

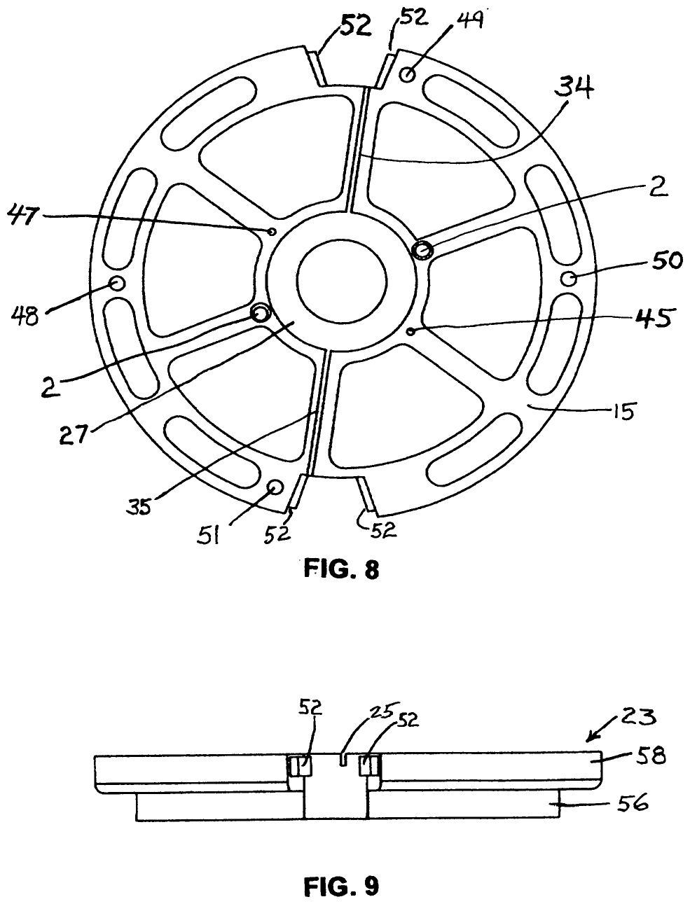

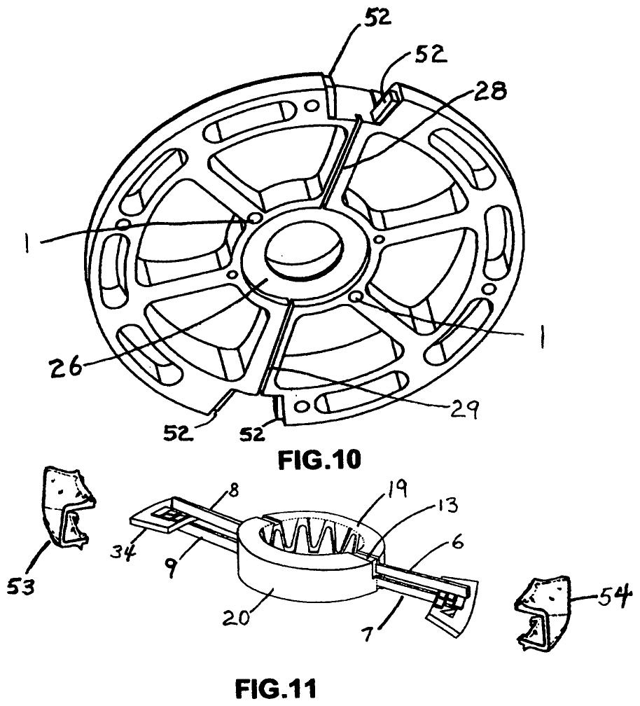

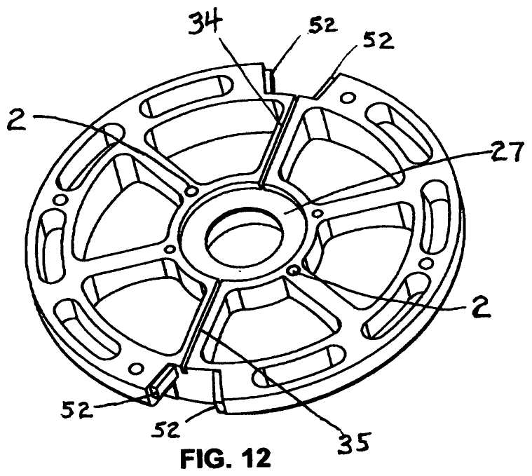

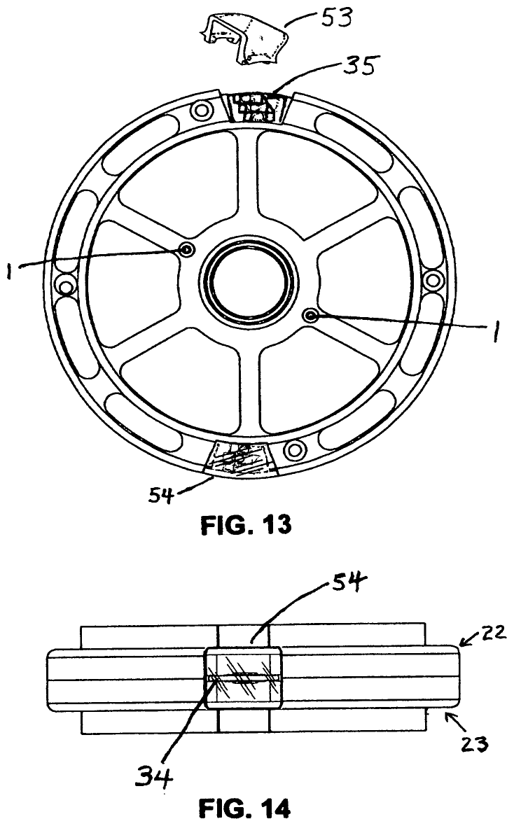

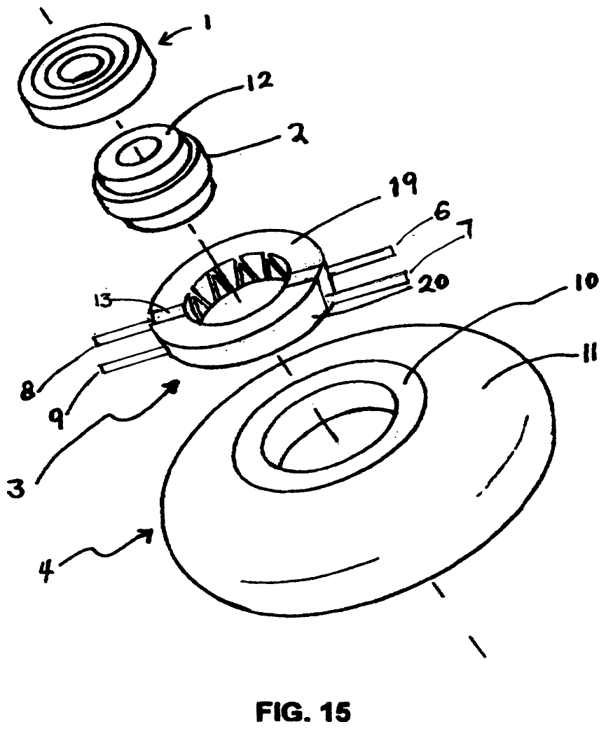

The present invention utilizes wheel hub 10 of aluminum or aluminum alloy that has been anodized to sufficient thickness, up to 2 to 2.5 mils (see for example Mil-A-8625 Type III hard anodic coating) to make it electrically insulative to prevent short circuiting electric devices contained in the wheel hub. The wheel hub comprises 2 panels, 22 and 23, each of which are anodized. The panels are secured together for example by using screws passing through or threaded through screw holes 1,2, and 38-43, 45, 47-51. Diameters of screw holes 38 and 39 in front panel and screw holes 45 and 47 in rear panel 23 are shown prior to assembling and are a smaller diameter than screw holes 2 in rear panel 23 and front panel 22, respectively because screws passing through the smaller diameter holes will screw in tighter. Other known means can be used to secure the two panels together. The wheel hubs panels have annular shoulders 26 and 27 for retaining ring type armature assembly 3 and channels 28 and 29 extending from the inner space holding the armature assembly. FIG. 4, and FIG. 8 show channels 28 and 29 in front and rear panel internal or interior faces 14 and 15 that are dimensioned to receive armature extensions or arms 6, 7, 8, and 9 extending through inner rims 55 and 56 and into display openings or recess spaces 30 and 31 in outer rims 57 and 58 as shown in FIG. 1 and into electrical contact with a light emitting surface mounted light emitting device or SMD such as LED bearing circuit boards 34 and 35. LED mounted circuit board is shown in the wheel rim of the hub in FIGS. 13 and 14. Armature arms 6-9 are uninsulated bare metal. The display openings or recessed spaces 30 and 31 in the outer rim of the wheel hub are dimensioned to hold the LED circuit board or other light emitting device. FIG. 2 shows channel openings 24 of channel 28 of front hub panel 22 and opening 25 of channel of rear hub panel 23. Each panel has support shoulders 52 dimensioned to hold and help support the light emitting device 34 and 35. It is noted that the shoulders can be omitted and electrical display device can be glued in. Each armature cover and electrically conductive extension or arm is advantageously made from a single piece of electrically conductive metal.

In one preferred embodiment, channels 28 and 29 of panel 22 are offset from and do not mate with channels 34 and 35 of rear panel 23. The offset can be seen in the position of armature arms 6 and 7 in FIG. 1. This embodiment uses the anodized inner surface of the panels to provide electrical insulation for the bare uninsulated electrically conductive armature arms until it is in electrical contact with the electrically operated display device. The channels can match each other as long as arms 6 and 7 are not in electrical contact while they are in the channels.

The display opening or recess in the outer rim of the wheel hub is covered by transparent or translucent caps 53 and 54 that seals the light emitting devices in the display opening as shown for example in FIGS. 13 and 14.

FIG. 15 is an exploded view showing wheel 4, wheel hub 10, and compact generator comprising a permanent magnet assembly of permanent magnet 2 carried on cylindrical element 12 that engages with wheel bearing 1 and axle (the opposite side wheel bearing. and axle are not shown) and armature assembly 3, which comprises armature covers 19 and 20 and .wire coil bobbin 13. Tire 11 is typically made of polymer or resin such as polyurethane and extends over the display opening and inner rim of the wheel hub. The compact generator and wheel operate in principal established in Kwon and Hyun.

The present wheel hub can be used for small diameter wheels, e.g., 40 mm and larger diameter wheels to 145 mm or more. The inventive wheel hub can be used in strollers, roller skates, in-line roller skates, skate boards and aggressive skate wheels. It can also be used in large diameter wheels for wheel chairs. It is understood various modifications and variations of the present invention such as material of construction, arrangement of light emitting devices, electrical and magnetic materials and elements are within the purview of the present invention.

I claim:

1. An aluminum or aluminum alloy wheel hub having at least one display opening for electrically operated display device and at least one interior channel anodized to a sufficient electrically insulative thickness, said channel dimensioned to receive at least one electrically conductive element, said channel extends into said opening from an interior space in said hub.

2. The wheel hub of claim 1, wherein said interior space comprises a space dimensioned to receive a compact generator for generating electricity positioned in said wheel hub.

3. The wheel hub of claim 1, wherein said interior space comprises a space dimensioned by an annular shoulder means dimensioned to receive and retain a compact generator for generating electricity positioned in said wheel hub.

4. The wheel hub of claim 1, wherein said interior space comprises a space defined by an annular shoulder dimensioned to receive and retain an armature assembly of a compact generator.

5. The wheel hub of claim 1, further comprising means for holding and retaining said electrically operated display device positioned in said at least one display opening.

6. The wheel of claim 5, wherein means for holding and retaining said electrically operated display device comprises shoulder means for holding and retaining said electrically operated device.

7. The wheel hub of claim 1, wherein said at least one interior channel comprises at least a first and a second interior anodized electrically channels anodized to sufficiently electrically insulative thickness extending into said display opening.

8. The wheel hub of claim 7, wherein said interior channels are offset from one another.

9. The wheel hub of claims 1, 7 and 8, wherein the wheel hub comprises two mating panels.

10. The wheel hub of claim 9, wherein one of said first and second channels is positioned on an interior surface of one of said mating panel and another one of said first and second channels is positioned in an interior surface of the other mating panel.

11. An aluminum or aluminum alloy wheel hub comprising a front panel having an exterior surface and an interior surface and rear panel having an exterior and an interior surfaces, said hub having at least one display opening for electrically operated display device, at least one interior channel in at least one of said front panel or rear interior surfaces anodized to a sufficient electrically insulative thickness, said channel dimensioned to receive at least one electrically conductive element, said channel extends into said opening from an interior space in said hub.

12. The wheel hub of claim 11, wherein said interior space comprises a space dimensioned by an annular shoulder means dimensioned to receive and retain a compact electric generator for generating electricity positioned in said wheel hub.

13. The wheel hub of claim 11, wherein said interior space comprises a space defined by an annular shoulder dimensioned to receive and retain an armature assembly of a compact generator.

14. The wheel hub of claim 11, further comprising means for holding and retaining said electrically operated display device positioned in said at least one display opening.

15. The wheel of claim 14, wherein means for holding and retaining said electrically operated display device comprises shoulder means for holding and retaining said electrically operated device.

16. The wheel hub of claim 11, wherein said at least one interior channel comprises at least a first and a second interior anodized channels anodized to sufficiently electrically insulative thickness extending into said display opening.

17. The wheel hub of claim 16 wherein said channels are offset from one another.

18. The wheel hub of claims 16, and 17, wherein one channel of said at least first and second interior anodized channels is positioned in one of said front panel and other interior anodized channel is positioned in the rear panel.

19. The wheel hub of claim 11, wherein said display opening is positioned in an outer rim of said hub.

20. A light emitting aluminum or aluminum alloy wheel hub and armature assembly for generating electricity having at least one display opening containing an electrically operated light emitting device, electrically conductive element means for electrically connecting said device to said armature assembly positioned in said wheel hub through at least one interior channel anodized to a sufficient electrically insulative thickness and dimensioned to receive said at least one electrically conductive element means, said channel extends into said opening from an interior space holding said armature in said hub.

21. The wheel hub of claim 20, wherein said wheel hub comprises 2 panels having said least interior channel anodized to a sufficient electrically insulative.

22. The wheel hub of claim 21, wherein said light emitting device is a LED.

23. The wheel hub of claim 20, wherein said display device is positioned in an outer rim of said wheel hub.

24. The wheel hub of claim 20, wherein said electrically conductive element comprises bare electrically conductive arms of said armature.

25. The wheel hub of claim 20, wherein said at least one interior channel comprises at least a first and a second interior anodized channels anodized to sufficiently electrically insulative thickness extending into said display opening.

26. The wheel hub of claim 25, wherein said interior channels are offset from one another.

27. The wheel hub of claims 20, and 26, wherein said wheel hub comprises two separate individual mating panels.

28. The wheel hub of claim 20, wherein said wheel hub has a rotatable permanent magnet assembly positioned in said wheel hub to generate electricity.

29. The wheel hub of claim 28, wherein wheel bearings are positioned in said hub to receive a wheel axle,

30. The wheel hub of claim 1, 11 or 20, wherein said wheel hub is positioned in at least one wheel of an apparatus selected from the group consisting of stroller, roller skate, in-line skate, aggressive skate, skate board, or wheel chair wheel.

31. A process of making the wheel hub of claim 1, 11 or 20, comprising, casting or machining aluminum or aluminum alloy to form said wheel hub; anodizing said wheel hub to a thickness sufficient to make said wheel hub electrically insulative.

32. The process of claim 31, further comprising inserting a compact electrical generator into operative position in said wheel hub.

33. The process of claim 32, further comprising positioning a light emitting device in a rim of said wheel hub in electrical contact with said compact generator.
